(19) United States
(12) Patent Application Publication
(10) Pub. No.: US 2003/0190023 A1
(43) Pub. Date: Oct. 9, 2003

(54) Apparatus and method for providing medical services over a communication network

(75) Inventors: Richard A. Farkas, Bloomfield Hills, MI (US); John R. Frassanito, Houston, TX (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(73) Assignee: Strategic Visualization, Inc., Bloomfield Hills, MI

(21) Appl. No.: 10/405,823

(22) Filed: Apr. 2, 2003

Related U.S. Application Data
(62) Division of application No. 09/697,226, filed on Oct. 26, 2000.
(60) Provisional application No. 60/162,381, filed on Oct. 29, 1999.

(51) Int. Cl. G06F 17/60; H04M 11/00

(52) U.S. Cl. 379/106.02; 705/2

(57) ABSTRACT

A system for providing medical services over the Internet is disclosed, having a patient system at a patient location, and a medical service provider system at a provider location. The patient system includes a monitoring system having various monitoring devices, each of which produce an electronic signal indicative of a particular physical or medical characteristic of a patient. Using these electronic signals, the monitoring system produces an output signal to an interface device which, in turn, provides input to a communication device adapted for communicating via the Internet. The medical service provider system includes apparatus for receiving the information sent by the patient system. In response, the provider system sends medical advice to the patient system, via the Internet, or, if the information received tends to indicate an emergency situation might exist, notifies emergency care givers in the vicinity of the patient location that emergency services are needed at the patient location.

### RELATED APPLICATIONS

This application is a divisional of U.S. patent application Ser. No. 09/697,226 filed Oct. 26, 2000, which claims priority of U.S. Provisional Patent Application 60/162,381 filed Oct. 29, 1999.

### BACKGROUND OF THE INVENTION

I. Field of the Invention

The present invention relates generally to medical services and related apparatus. More particularly, the present invention relates to an apparatus and method for monitoring patients and providing medical services to such patients, via the Internet, a local area network, or other communications medium.

II. Description of the Prior Art

The senior population of the United States, and of the world, is rapidly increasing. Six thousand people reach age 65 every day, and the number is increasing; the over age 65 population is expected to reach roughly 90 million by the year 2010. Senior citizens—those over 65—are living longer; the fastest growing segment of the United States population is that of people over the age of 85. Seventy percent of the senior citizen population in the United States is expected to require nursing home or assisted living care. Nursing homes are unable to meet the demand, and traditional family support roles tend to diminish as families disburse.

As seniors age, medical problems become more frequent. Most medical catastrophes can be avoided with monitoring and early treatment. Monitoring, however, is problematic, especially outside of a nursing home environment or a hospital environment. The present invention is directed to overcoming, or at least reducing, some of these problems by applying state of the art telecommunications and computer technology to monitoring and early treatment.

Reported telemedicine systems have usually been directed toward image manipulation, transmission of ultrasound medical images, and video and audio teleconferencing. Such reported systems are usually intended to permit a health care provider in one location to confer with colleagues in another location, and to receive from those colleagues diagnostic and patient treatment information for the health care provider to use in treating a patient. Such reported systems, however, appear to be primarily intended for use between a local medical service provider and a remote teaching hospital facility or diagnostic facility.

Other reported systems include tiny skin sensors used to monitor premature infants in hospital nurseries, and experimental skin temperature monitors used by climbers for transmitting data, via satellite, to certain medical schools.

No known reported systems apply state of the art telecommunications and computer technology to provide monitoring and medical service apparatus capable of readily being used in the average home, and affordable by the average person.

The present invention is directed to overcoming, or at least reducing, the effects of one or more of the problems mentioned above.

### SUMMARY OF THE PRESENT INVENTION

In one aspect of the present invention, provided is a system for providing medical services over the Internet, between a patient location and a medical service provider location. The system includes a patient system and a medical service provider system, each adaptable for communicating with one another, via the Internet. The patient system includes a health monitoring system having various monitoring devices, each operable to produce an electronic signal regarding a particular patient medical condition. The monitoring system produces an output signal reflecting at least some of the information received from at least one of the monitor devices. That output signal is received by an interface device which, in turn, provides an input signal to a communication device adapted for communicating via the Internet. The medical service provider system includes a communication device operable to receive the information sent from the patient system, via the Internet, and further operable to send medical provider information to the patient system.

According to another aspect of the present invention, the monitoring devices of the patient system can include a stethoscope subsystem, a thermometer subsystem, a blood pressure subsystem, a retina scan subsystem, and other monitoring devices capable of monitoring a patient's medical condition or monitoring the physical characteristics of a patient or the patient's environment, as well as devices, such as a medicine dispenser device, which can be used to provide services to a patient.

### BRIEF DESCRIPTION OF THE DRAWINGS

Other advantages of the invention will become apparent upon reading the following detailed description and upon reference to the drawings in which:

FIG. 1 illustrates, in block diagram form, a system for providing medical services according to one aspect of the present invention;

FIG. 2 illustrates a health monitoring system according to one embodiment of the present invention;

FIG. 3 illustrates a patient system having multiple individual health monitoring systems, according to another aspect of the present invention;

FIG. 4 illustrates a patient system having multiple individual health monitoring systems, according to yet another aspect of the present invention;

FIGS. 5 and 6 illustrate various different monitoring systems according to still other embodiments of the present invention;

FIG. 7 illustrates, in pictorial form, a medicine dispenser device according to one aspect of the present invention;

FIG. 8 illustrates, in pictorial form, an intelligent mattress device according to another aspect of the present invention;

FIG. 9 illustrates, in pictorial form, a home monitoring system according to yet another aspect of the present invention; and

FIG. 10 illustrates, in pictorial view, a home health monitoring system according to one aspect of the present invention.

### DETAILED DESCRIPTION OF PREFERRED EMBODIMENTS OF THE PRESENT INVENTION

Illustrative embodiments of the invention are described below. In the interest of clarity, not all features of an actual implementation are described in the specification. It will of course be appreciated that in the development of any such actual embodiment, numerous implementation-specific decisions must be made to achieve the developer's specific goals, such as compliance with system-related and business-related strengths, which will vary from one implementation to another. Moreover, it will be appreciated that such a development effort might be complex and time-consuming, but would nevertheless be a routine undertaking for those of ordinary skill in the art having the benefit of this disclosure.

The present invention permits remote monitoring of patients, and the providing of medical services at a location remote from the health care provider. According to one aspect of the present invention, the World Wide Web or Internet is advantageously used as a communications medium. Other media can also be used, including but not limited to an intranet, a local area network (sometimes referred to as a LAN), a telephone transmission line (be it a physical line, or other transmission means used by commercial phone service providers), digital lines, a radio frequency or other carrier, and so forth, as will be apparent to those skilled in the art having benefit of the present disclosure.

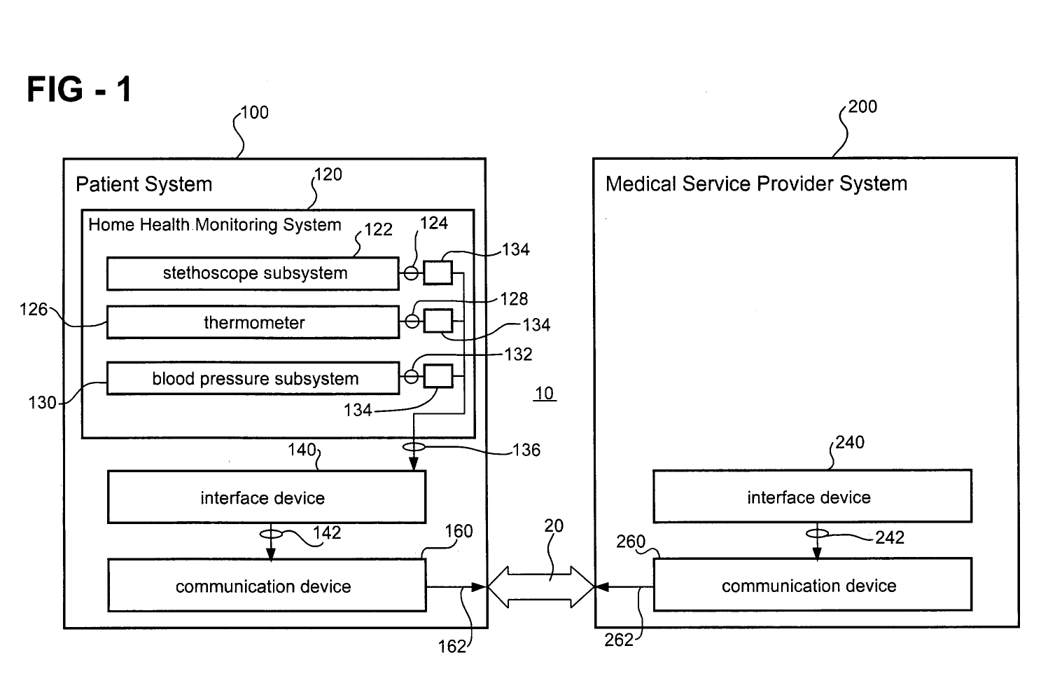

Referring now to the drawings and in particular to FIG. 1, illustrated in block diagram form is a system for providing medical services 10 having a patient system 100 and a medical service provider system 200, each adaptable for communicating via the Internet as diagrammatically shown by the arrow symbol 20. As will be apparent to those skilled in the art having benefit of this disclosure, the connection 20 may be any desired communication medium, and may include, without limitation, a bus, modems or routers connected to a dial-up telephone line or digital line, a LAN, a dedicated digital line, an infrared (IR) light path, a radio frequency or other carrier, a connection to the Internet using any of the foregoing, and so forth. So as to simplify the discussion contained in this disclosure, reference to the Internet will continue to be made, intending to refer to any desired communication medium.

According to one aspect of the present invention, the patient system is located at a patient location, and is selectively operable to send patient information, via the Internet, to the medical service provider system. The medical service provider system is located at a medical service provider location remote from the patient location, and is selectively operable to receive, via the Internet, the patient information sent from the patient system. According to another embodiment of the present invention, the medical service provider system is also operable to send medical provider information, via the Internet, to the patient system, and the patient system is operable to receive such information. As will be apparent to those skilled in the art having benefit of this disclosure, the medical provider information or the patient information, or both of them, may contain data, audio, and/or video information.

With continued reference to FIG. 1, the patient system 100 includes a home health monitoring system 120, having one or more monitor subsystems, each of which produce one or more electronic signals indicative of a patient's medical condition. For example, illustrated in FIG. 1 is a stethoscope system 122, operable to sense heart rate and provide an electronic signal 124 indicative of that heart rate; a thermometer system 126, operable to sense temperature and provide an electronic signal 128 indicative of that temperature; and a blood pressure subsystem 130, operable to sense blood pressure and provide an electronic signal 132 indicative of that blood pressure. In one embodiment of the present invention, each monitor subsystem is a separate module having at least one sensor operable to sense a patient condition (e.g., heart rate), structure to produce an electronic signal indicative of the patient condition sensed, and structure to connect the module to the monitoring system.

The patient system further includes a plurality of devices 134 wherein one device 134 is associated with each monitor subsystem 122, 126 and 130. Each monitoring device receives the electronic signal from its associated monitor subsystem, and provides an output signal 136 indicative of the electronic signals from its associated monitor subsystem. As will be apparent to those skilled in the art having benefit of this disclosure, one or more of the electronic signals provided by one or more of the monitors may be selectively combined and/or otherwise manipulated to produce information which, according to another aspect of the present invention, may be contained in the output signal 136 in combination with, or to the exclusion of, other information.

The patient system 100 also includes an interface device 140, which receives the output signal 136 and provides an input signal 142 to a communication device 160. In the illustrated embodiment, the communication device 160 is shown connected to the Internet 20 by a line 162. As will be apparent to those skilled in the art having benefit of the present disclosure, the device 134 may be a physical line, an infrared connection, or any other suitable connection. In addition, the line 162 may be a physical line or any other suitable connection.

In other embodiments of the present invention, the home health monitoring system includes other monitor devices. For example, in one embodiment of the present invention, the monitoring system includes a breath analyzer subsystem, having a breath analyzer device, operable to analyze breath and provide an electronic signal indicative of the breath.

In another embodiment, the system includes a retina scan subsystem, having a camera device, operable to scan a retina and provide an electronic signal indicative of the retina. Because human retinas are unique, the retina scan device can be used to provide positive identification of a particular patient.

In yet another embodiment of the present invention, the system includes an exercise monitor subsystem having a remote cuff device which may be attached to the patient's body. In operation, the remote cuff device senses heart rate and provides an electronic signal to the exercise monitoring subsystem, and the exercise monitoring subsystem in turn provides an electronic signal indicative of heart rate.

In still another embodiment, the system includes an EKG subsystem, having an EKG monitoring device, operable to measure heart function and to provide an electronic signal indicative of that heart function.

According to another embodiment of the present invention, the stethoscope subsystem is operable to sense pulmonary function and provide an electronic signal indicative to that pulmonary function. According to yet another embodiment, the blood pressure subsystem is operable to sense heart rate and provide an electronic signal indicative of that heart rate.

In another embodiment of the present invention, the patient system includes a camera subsystem, having a camera device, operable to view an image, for example, the patient, and provide an electronic signal indicative of the image being viewed by the camera device.

In yet another embodiment, the patient system includes one or more devices, such as a medical dispenser device described more fully below, adapted to provide services to the patient, for example dispensing medicines.

With continued reference to FIG. 1, the medical service provider system 200 includes an interface device 240, which provides an input signal 242 to a communication device 260. In the illustrated embodiment, the communication device 260 is connected to the Internet 20 by a line 262. As will be apparent to those skilled in the art having benefit of the present disclosure, the line 262 may be a physical line or any other suitable connection.

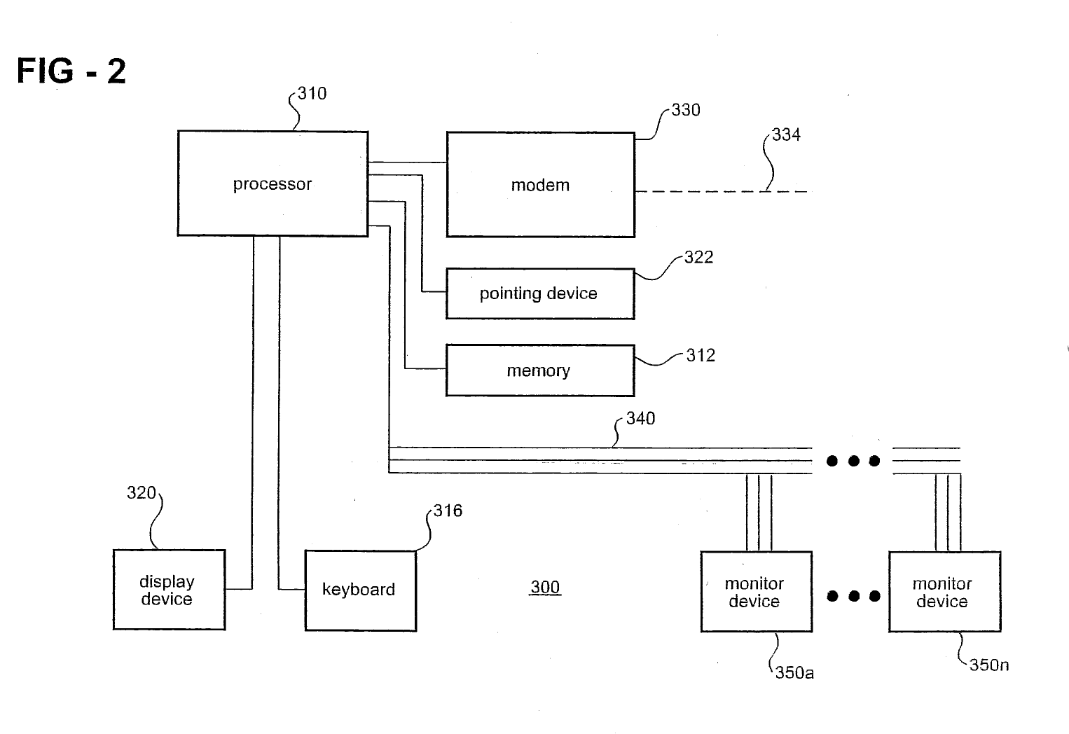

Referring now to FIG. 2, in another embodiment of the present invention, a health monitoring system 300 includes a processor 310. The processor may advantageously have on-board memory and/or additional memory 312, operable to include software so that the processor may control, at least to some extent, operation of the health monitoring system. In yet another embodiment of the present invention, the memory, either on-board memory contained in the processor 310 and/or the memory 312, and/or additional memory not illustrated, advantageously is used to store patient related information. The information so stored may advantageously be used for historic purposes, or for subsequent transmission to the medical service provider location, or for subsequent query by either the medical service provider system, or by the patient system.

With continued reference to FIG. 2, the health monitoring system 300 includes a keyboard or other input device 316, operable to permit the patient or another person at the patient location to enter information into the health monitoring system. Also included is a display device 320, which may be a cathode ray tube (CRT) monitor, a flat panel display, or any other suitable display device. In operation, the display device 320 is selectively operable to display information contained in the health monitoring system, or information being monitored by the system, or information received by the system. A pointing device 322 is also included, and may advantageously be used for pointing to information displayed on the display device 320.

The health monitoring system 300 also includes a modem 330 or other suitable modulator capable of encoding information, controllable by the processor 310, and adaptable to communicate with a communication line 334. The communication line 334 may be a telephone company line, a local area network line, or any other suitable medium.

With continued reference to FIG. 2, the health monitoring system 300 has a bus 340, controllable by the processor 310, and operable to selectively communicate with monitor devices 350a, 350b, . . . , 350n connected to the bus. According to one embodiment of the present invention, the bus advantageously is a USB bus. According to other embodiments, one or more monitor devices communicate with the system via multiple RS232 ports, a separate LAN, an IR network, or a peripheral bus.

The monitor devices 350a, 350b, . . . , 350n may be any suitable monitor device, for example, the stethoscope subsystem 122, the thermometer subsystem 126, the blood pressure subsystem 130, the breath analyzer subsystem, the retina scan subsystem, the medicine dispenser device, or the intelligent mattress device described more fully below, and so forth.

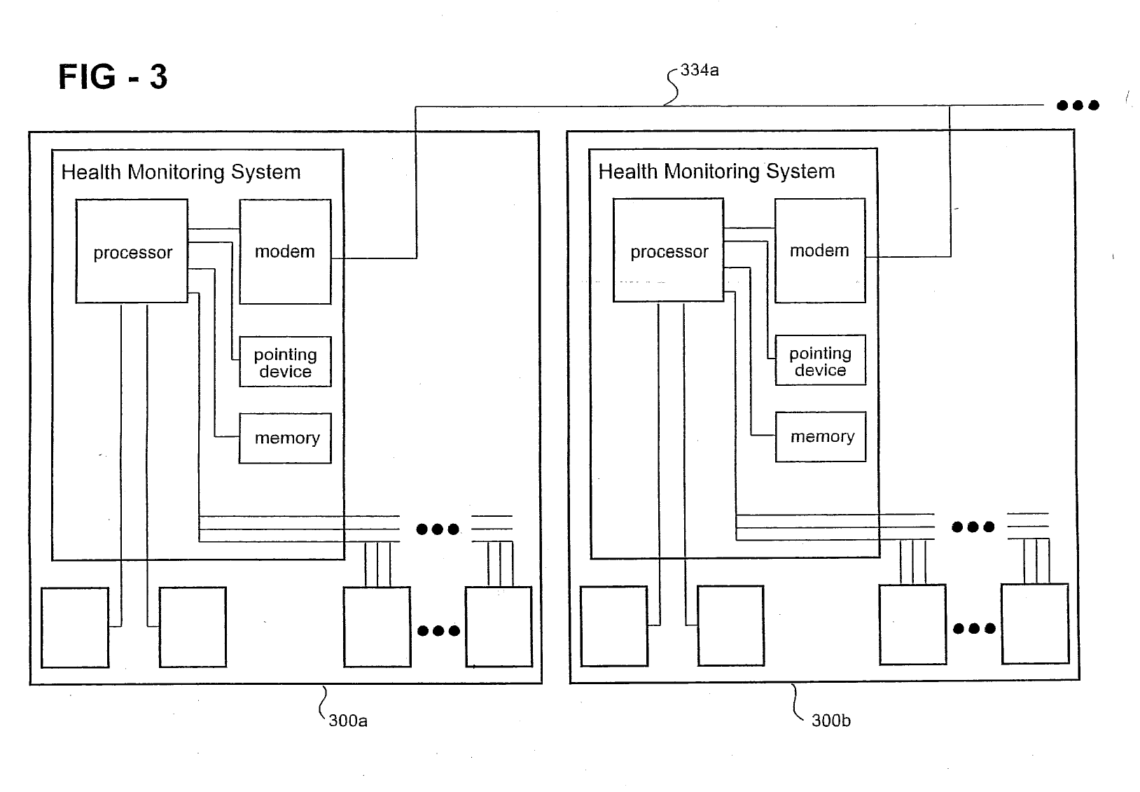

Referring now to FIG. 3, illustrated is another embodiment of the present invention, in which two health monitoring systems, 300a and 300b (each similar to the health monitoring system 300 illustrated in FIG. 2), are connected together in a local area network, via a local area network line 334a. Advantageously, either or both of the monitoring systems 300a and 300b, may be accessed over the local area network, thus permitting a medical service provider system connected to the local area network to selectively access one or more of the health monitoring systems connected to the local area network. As will be apparent to those skilled in the art having benefit of the present disclosure, any desired number of health monitoring systems may be advantageously connected in the local area network, similarly, the local area network might be in a hospital, a retirement home, a health care facility, an apartment complex, and so forth, as desired.

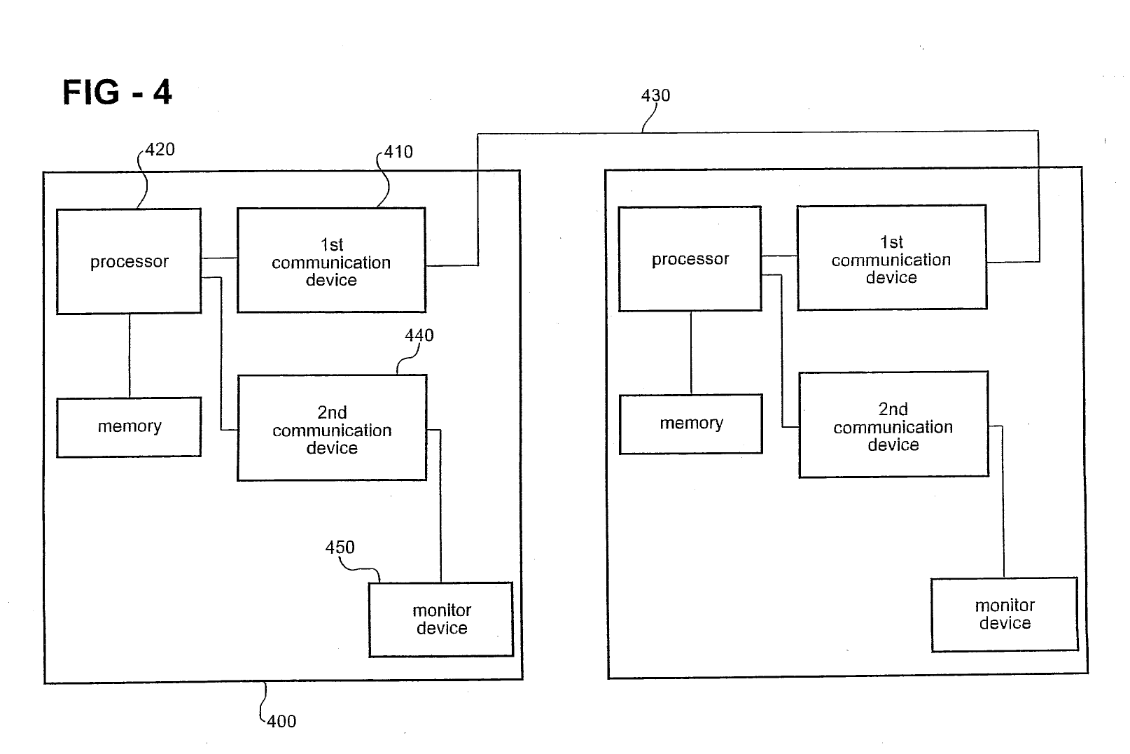

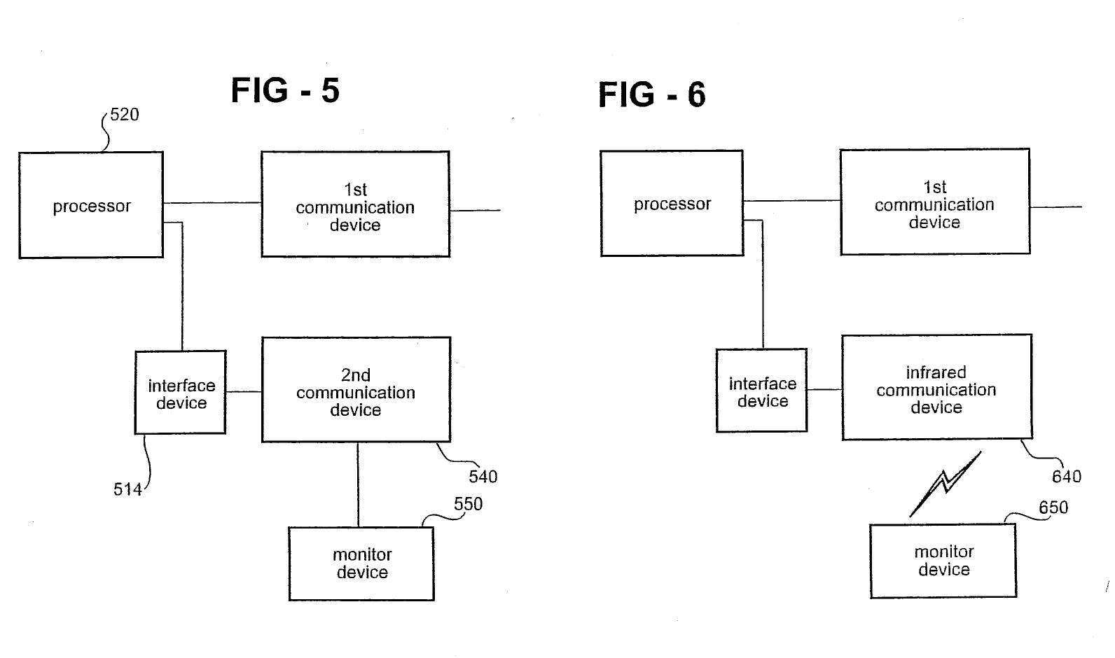

Referring now to FIG. 4, according to another embodiment of the present invention, a monitoring system 400 includes a first communication device 410, controllable by a processor 420, and adaptable to communicate with a communication line 430. The monitoring system 400 also includes a second communication device 440, controllable by the processor 420, and operable to communicate with a monitor device 450. In yet another embodiment, illustrated in FIG. 5, an interface device 514, controllable by a processor 520, interfaces with a second communication device 540 which, in turn, communicates with a monitor device 550. In still another embodiment, illustrated in FIG. 6, an infrared communication device 640 selectively communicates with a monitor device 650 capable of infrared communication.

In another embodiment of the present invention, the medical service provider system includes a display device operable to selectively display information representative of the output signal of the home health monitoring system. In yet another embodiment, the medical service provider system includes memory operable to selectively store patient information. In still another embodiment, the medical service provider system advantageously contains medical advice, which advice is communicated to the patient system, via the Internet or other means, in response to patient information.

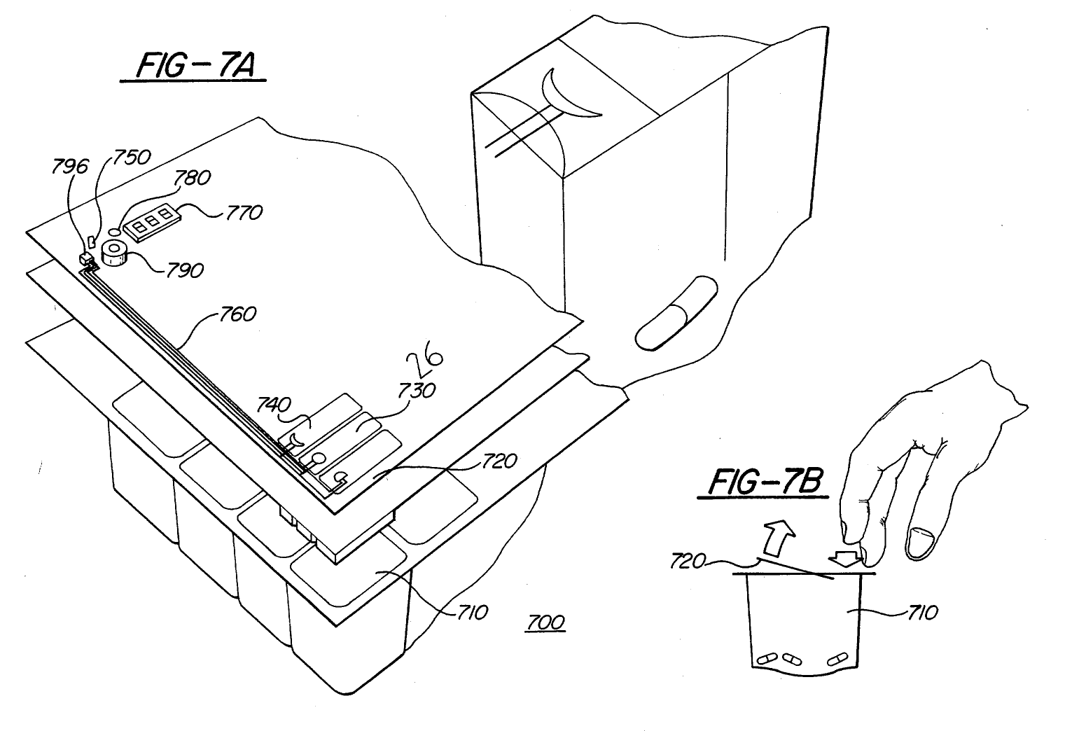

FIG. 7 illustrates, in pictorial form, a medicine dispenser device 700 according to one aspect of the present invention. In one embodiment, the medicine dispenser device 700 is connected to the patient system by an interface device (not illustrated) selectively operable to permit communication between the medicine dispenser device and other apparatus contained in the patient system.

With continued reference to FIG. 7, the medicine dispenser device 700 includes one or more medicine containment portions 710, adaptable to contain medicine. As will be apparent to those skilled in the art having benefit of the present disclosure, one or more items different from medicine may advantageously be contained within the containment portion 710.

As illustrated in FIG. 7, the medicine containment portion 710 has a covering member 720 which can be in a closed condition or in an open condition. In the closed condition, the medicine is contained in and kept within the medicine containment portion. In the open condition, the medicine contained within the medicine containment portion can readily be accessed.

With continued reference to FIG. 7, the medicine dispenser device 700 includes an indicator device 730, such as an LCD flashing indicator or any other suitable indicator device, which, in operation, may be used to identify a particular medicine containment portion 710 in the medical dispenser device 700. The indicator device 730 communicates with the patient system, and is selectively turned on, for example, made to flash, when the patient is intended to take the medicine contained within the particular medicine containment portion associated with the particular indicator device.

The medicine dispenser device 700 also has, in association with a particular covering member and containment portion, a means 740 for sensing whether the particular medicine containment portion is open or closed, that is, whether the covering member 720 associated with the particular medicine containment portion is in the open condition or in the closed condition.

With continued reference to FIG. 7, in one embodiment of the present invention, the medicine dispenser device includes an infrared device 750 or other means for communicating with the interface device and/or with other apparatus contained in the patient system. The device 750, in the illustrated embodiment, is connected by various printed wire lines 760 to the indicator device 730 and to the means for sensing 740.

In yet other embodiments of the present invention, the medicine dispenser device includes a clock display device 770, an alarm 780, a battery 790, and a controller 796. In operation, the clock display may be used to apprise the patient of the time of day, as a reminder for when particular medicine needs to be taken. The alarm may advantageously be used to warn the patient that medicine has not been taken as needed, thereby alerting the patient, by the sound of the alarm, to look at the medicine dispenser and see which indicator device is on, for example, which LCD indicator is flashing, so that the patient may take the appropriate medicine contained in the medicine containment portion associated with the flashing indicator.

Once the covering member 720 has been opened, the processor will remember and store the date the member was opened.

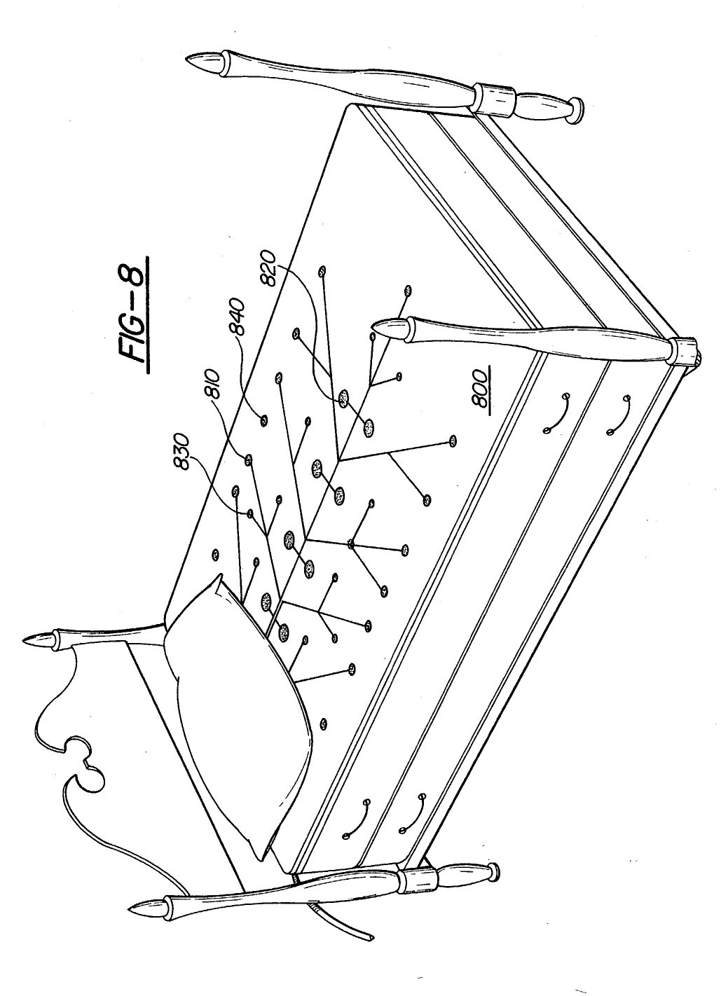

Referring now to FIG. 8, in still another embodiment of the present invention, the patient system includes an intelligent mattress device 800. The intelligent mattress device 800, includes one or more sound sensing devices 810, operable to sense sound and provide an electronic signal indicative of the sound sensed. The sound sensing devices permit monitoring of a patient's breathing and other sounds, as the patient sleeps.

The intelligent mattress device 800 further includes one or more moisture sensing devices 820, operable to sense moisture and provide an electronic signal indicative of that moisture. The moisture sensing devices permit monitoring of the patient's perspiration and urinary functions.

The intelligent mattress device 800, in one embodiment, includes one or more temperature sensing devices 830, operable to sense temperature of the patient, and provide an electronic signal indicative of the patient's temperature. Also included are pressure sensing devices 840, operable to sense pressure on the mattress and produce an electronic signal indicative of that pressure, thereby providing information about which patient is lying where on the mattress (for example, sensing a female patient's lighter weight in one portion of the mattress, and a male patient's heavier weight in another portion of the mattress), and sensing whether or not the patient is presently in bed. The data from the mattress device is communicated to the network, such as the Internet, by any conventional means, such as a hardware connection, infrared, modem and the like.

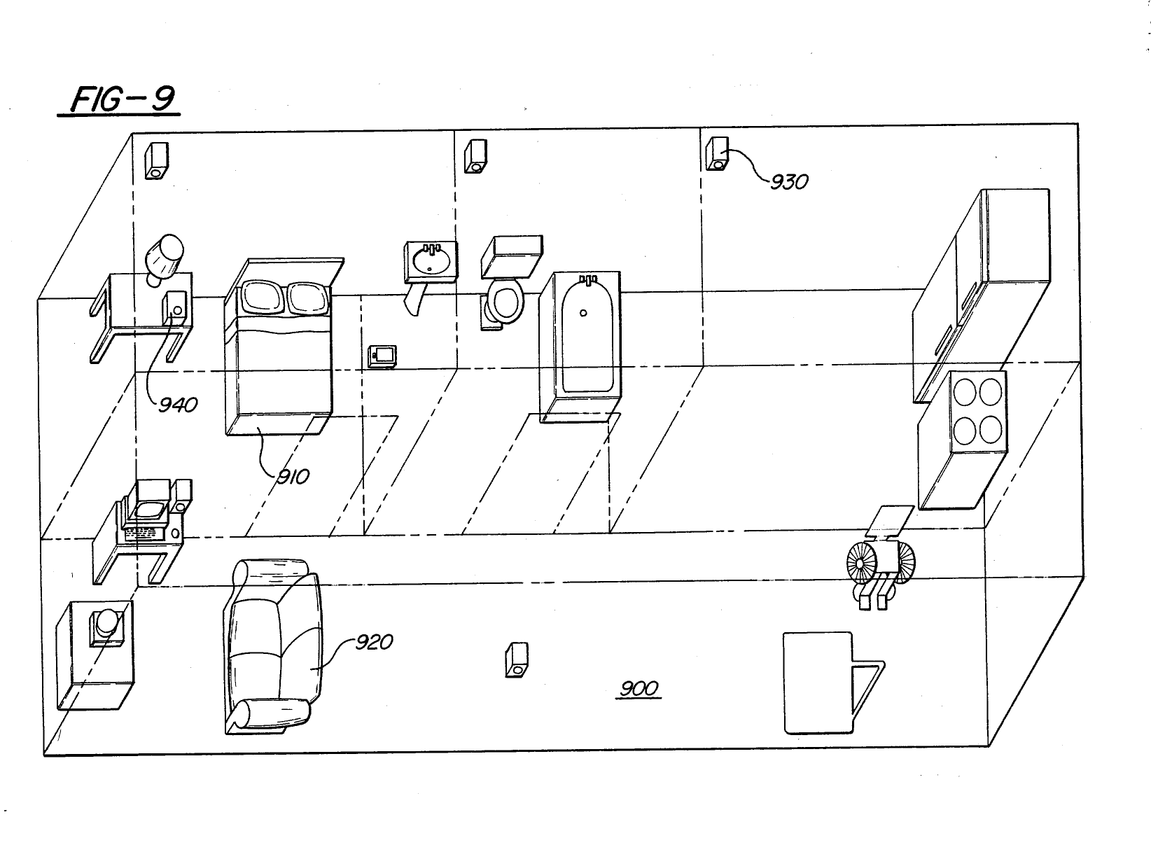

Referring now to FIG. 9, illustrated in pictorial form are portions of a patient system 900. The illustrated system includes an intelligent mattress device 910, a couch device 920 having embedded pressure sensors, as well as various other appliances and facilities having sensors for monitoring their use by the patient and their present condition. The system also includes various video devices 930 for monitoring the patient environment, as well as monitoring devices 940 for measuring the patient's vital signs. In yet another embodiment of the system, included is a patient location device system having a personal man-down subsystem, including an attitude sensor operable to determine horizontal versus vertical attitude, a personal man-down pager, an emergency panic button, embedded health records, and electronics for communicating with other apparatus contained in the system. Included in yet another embodiment is a recent motion subsystem operable to produce an electronic signal indicative of when a patient is in motion, for example, walking. According to another aspect of the present invention, various of the devices in the system 900 are connected to a controller via hard wire connections, and other devices are connected via infrared transceivers.

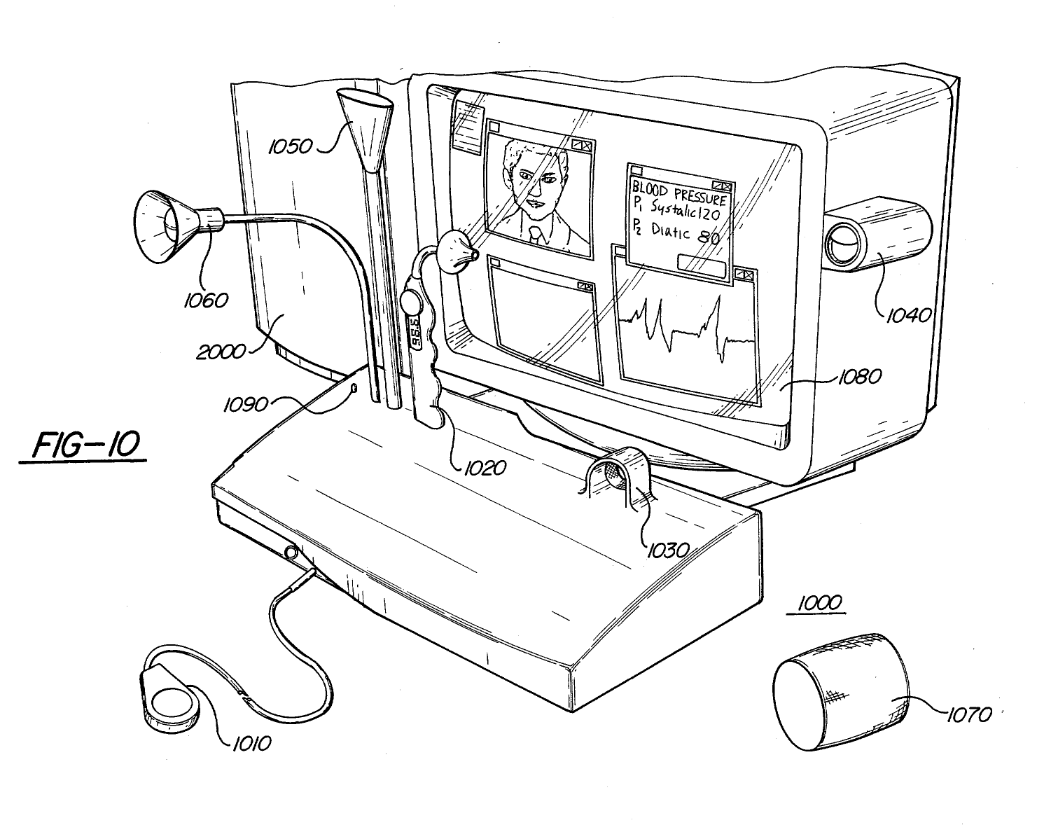

Referring now to FIG. 10, illustrated in pictorial form is a home health monitoring system 1000, having a stethoscope subsystem 1010, a thermometer subsystem 1020, and a blood pressure system 1030. Also included is a camera device 1040, a breath analyzer subsystem 1050, a retina scan subsystem 1060, an exercise monitor remote cuff device 1070, and a display device 1080. In the illustrated embodiment, the remote cuff device 1070 includes an infrared transceiver device, which communicates with a cooperative transceiver device 1090. In the illustrated embodiment, a computer device 2000 controls operation of the patient system.

The embodiment illustrated in FIG. 10 may advantageously include an audio device (not illustrated). The audio device and the camera device 1040 may then be advantageously used for audio and video communication between a patient at the patient location and a health care provider at the medical service provider location. As will be appreciated by those skilled in the art having benefit of this disclosure, some aging patients will need more human-to-human coaching and attention than others, and some will not remember to do things they are scheduled to do on a regular basis (such as take medicine). The apparatus according to one aspect of the present invention permits the health care provider to call the patient, talk with and observe the patient, and walk the patient through necessary procedures. The apparatus further permits the health care provider to assess the medical, physical, and mental condition of the patient and to provide care as needed. For example, if the attitude sensor in the personal man-down system indicates the patient is in a horizontal position, and the patient has been in that position for a prolonged period of time, the health care provider might sound an alarm at the patient location summoning the patient to communicate with the health care provider via the audio device and the camera device. If the patient does not respond, the health care provider might alert emergency care providers in the vicinity of the patient location that emergency services are needed at the patient location. Similarly, the health care provider, via the patient system, might determine that the patient is experiencing a high or low rate of pulse, or an abnormal skin temperature, or other warning condition, and summon the patient to the audio/visual communication devices or alert emergency care providers as needed.

In yet another embodiment, the audio/visual communication devices may be used by the patient for day-to-day communications, permitting the patient to communicate with others having a telephone, a picture phone, or any other desired communication device.

As will be apparent to those skilled in the art having benefit of the present disclosure, in use the medical service provider location need not be that of a professional health care provider; it may advantageously be the location of the patient's son or daughter or other relative or concerned friend. Additionally, a system according to the present invention may have more than one health care provider system and location. For example, one health care provider system might be located at a professional health care provider facility and another at the home of the patient's son or daughter, thereby permitting both the professional health care provider and the son or daughter to interact with the patient and with each other.

According to another aspect of the present invention, provided is a method for providing medical services over the Internet, between a patient location and a medical service provider location. According to the present method, the patient system, at the patient location, senses a physical condition of the patient, creates an electronic signal indicative of the physical condition sensed, and transmits information indicative of the physical condition sensed to the medical service provider location. The medical service provider location then receives the information, and provides services in response to the information received. According to one aspect to the present invention, the services provided in response to the information include transmitting medical advice from the medical service provider system to the patient system. According to another aspect of the present invention, when the information received indicates an emergency situation might exist at the patient location, the services provided include notifying an emergency care provider in the vicinity of the patient location that emergency services are needed at the patient location.

According to another aspect to the present invention, the method includes storing in a memory device at the patient location, historic data regarding the physical condition sensed, and providing such historic data to the medical service provider system upon receipt of an appropriate query signal.

The particular embodiments disclosed above are illustrative only, as the invention may be modified and practiced in different but equivalent manners apparent to those skilled in the art having benefit of the present disclosure. Furthermore, no limitations are intended to the details of construction or design shown herein, other than as described in the claims below. It is therefore evident that the particular embodiments disclosed above may be altered or modified, and all such variations are considered within the scope and spirit of the invention. Accordingly, the protection sought is as set forth in the claims below.

We claim:

1. A monitoring system comprising:
a processor;
a modem, said modem being controllable by the processor and adaptable to communicate with a communication line;
a monitor device; and
a bus, said bus being controllable by the processor and operable to selectively communicate with the monitor device.

2. The system of claim 1 further comprising:
a display device,
wherein the monitor device produces an electronic signal indicative of what is being monitored by said monitor device, and
wherein said display device is selectively operable to display information indicative of the electronic signal of the monitor device.

3. The system of claim 1 further comprising a pointing device selectively operable to point to information displayed on the display device.

4. The system of claim 1 further comprising:
an input device, said input device being selectively operable, and being controllable by the processor.

5. The system of claim 1 where the input device is a keyboard.

6. The system of claim 1 wherein the communication line is a local area network.

7. The system of claim 1 wherein the communication line is a telephone line.

8. A home health monitoring system comprising:
a first unit;
a second unit; and
a communication line;
wherein said first unit includes:
a first processor;
a first data modulator, said first data modulator being controllable by the first processor and operable to selectively communicate with the communication line;
a first monitor device; and
a first bus, said first bus being controllable by the first processor and operable to selectively communicate with the first monitor device;
wherein said second unit includes:
a second processor;
a second data modulator, said second data modulator being controllable by the second processor and operable to selectively communicate with the communication line;
a second monitor device; and
a second bus, said second bus being controllable by the second processor and operable to selectively communicate with the second monitor device,
wherein the communication line is a local area network line;
wherein the first bus is a USB bus; and
wherein the second bus is a USB bus.

9. A monitoring system comprising:
at least two units; and
a communication line;
wherein at least one of the at least two units includes:
a processor;
a first communication device controllable by the processor and operable to selectively communicate with the communication line;
a monitor device; and
a second communication device controllable by the processor and operable to selectively communicate with the monitor device.

10. The system of claim 9, wherein the at least two units includes a unit having:
a processor;
a communication device controllable by the processor and operable to selectively communicate with the communication line;
a monitor device;
an infrared communication device selectively operable to communicate with the monitor device; and
an interface device controllable by the processor and operable to selectively communicate with the infrared communication device.

11. The system of claim 9, wherein the at least two units includes a unit having:
a processor;
a first communication device controllable by the processor and operable to selectively communicate with the communication line;
a monitor device;
a second communication device selectively operable to communicate with the monitor device; and
an interface device controllable by the processor and operable to selectively communicate with the second communication device.
